(19) United States
(12) Patent Application Publication
(10) Pub. No.: US 2026/0279206 A1
(43) Pub. Date: Sep. 17, 2026

(54) FRAGMENTATION OF AVIONICS INPUT DATA FOR OFFBOARD VALIDATION

(71) Applicant: Honeywell International Inc., Charlotte, NC (US)

(72) Inventors: Muthusankar Subramaniyan, Brno (CZ); Dominik Schneiderka, Frenštát pod Radhoštem (CZ)

(21) Appl. No.: 19/213,695

(22) Filed: May 20, 2025

(30) Foreign Application Priority Data
Mar. 13, 2025 (IN) 202511022639

(51) Int. Cl. G08G 5/26; G08G 5/23; G08G 5/34

(52) U.S. Cl. CPC G08G 5/26; G08G 5/23; G08G 5/34

(57) ABSTRACT

A computing device onboard an aircraft for uploading flight plan data to a flight management system of an aircraft is configured to receive, by the first computing device, a flight plan; convert, by the first computing device, the flight plan into a data format supported by the flight management system to generate the FMS flight plan data; transmit a copy of the FMS flight plan data to a second computing device that is external to the aircraft; transmit, from the first computing device to the second computing device, an indication of a version of the flight management system; and in response to receiving, from the second computing device, a validation confirmation message indicating that the FMS flight plan data is valid for the version of the flight management system, transmit a connectivity message including the FMS flight plan data to the flight management system.

This application claims the benefit of Indian Provisional Patent Application No. 202511022639, filed Mar. 13, 2025, the entire contents of which are incorporated herein by reference.

### TECHNICAL FIELD

This disclosure relates to communication between aircraft systems and external devices.

### BACKGROUND

Vehicle operation and route planning technology increasingly relies on computer-based systems for obtaining current, most up-to-date data in order to determine an efficient and economical navigation plan. Vehicle operation and route planning technology also increasingly relies on computer-based systems to analyze past data in order to determine if a flight was flown in an efficient manner and to determine how operations can be improved. Such computation not only involves data captured and kept on-board the vehicle, but also involves data collected and analyzed off-board, such as by cloud-based analytics services.

### SUMMARY

The avionics of an airplane are specialized computing devices that may not receive frequent hardware updates. Thus, the processing capabilities of the avionics may be relatively slow compared to an electronic flight bag (EFB) or other newer computing devices, which may be external to the aircraft or otherwise not built into the aircraft. Due to hardware limitations, many avionics systems do not have the ability to buffer, or otherwise store, multiple fragments including flight plan data for long periods of time. Thus, if any one fragment of the flight plan fails the validation, then some flight management systems may reject the entire flight plan, requiring the pilot or other user to re-upload the entire flight plan, rather than just the fragment that failed validation, and thus requiring the FMS to re-validate already-validated fragments.

Additionally, EFB-FMS connectivity also potentially presents a security vulnerability that could be exploited by a nefarious actor. For example, cyber criminals could potentially utilize the connectivity channels between EFB applications and avionics to attack, or even take control of, the avionics. For instance, a cybercriminal could take control of an existing EFB application and then, posing as a legitimate EFB application, send malicious commands to the avionics using communication paths allocated for the legitimate EFB applications. Accordingly, EFB-FMS connectivity sessions are typically configured to be highly secure, which often involves limiting the FMS to only communicate with one external device at a time.

Given the relatively slow processing capabilities of the avionics and the fact that other devices may be blocked from communicating with the avionics while the EFB is uploading the flight plan, the process of uploading a flight plan to an FMS can create a bottleneck in the flight preparation process, particularly when a large flight plan fails multiple validation attempts. This disclosure describes techniques that may reduce this bottleneck by having an offboard computing devices, such as a cloud-based device or airport-based device, perform a pre-validation of the flight plan prior to the EFB uploading the flight plan to the FMS. By transmitting the plurality of fragments to an offboard computing device, and then in response to receiving a validation confirmation message from the offboard computing device, transmitting a connectivity message with the flight plan to the FMS, the techniques of this disclosure may reduce the number of times that an FMS will reject the flight plan, which may speed up and generally improve the flight preparation process for pilots. Moreover, the techniques of this disclosure may potentially achieve this benefit without requiring any hardware or software updates to the avionics of an aircraft.

According to an example of this disclosure, a computer-implemented method of uploading flight plan data from a first computing device to a flight management system of an aircraft includes receiving, by the first computing device, a flight plan; generating, by the first computing device, flight plan data for the flight plan; transmitting a copy of the flight plan data to a second computing device that is external to the aircraft; and in response to receiving a validation confirmation message from the second computing device, transmitting a connectivity message including the flight plan data to the flight management system.

According to another example of this disclosure, a computing device onboard an aircraft for uploading flight plan data to a flight management system of an aircraft includes one or more memories and processing circuitry coupled to the one or more memories and configured to receive a flight plan; generate flight plan data for the flight plan; transmit a copy of the flight plan data to a second computing device that is external to the aircraft; and in response to receiving a validation confirmation message from the second computing device, transmit a connectivity message including the flight plan data to the flight management system.

According to another example of this disclosure, a computer-implemented method of validating flight plan data for a flight management system of an aircraft includes receiving, from a first computing device onboard the aircraft by a second computing device offboard the aircraft, flight plan data; determining a version for the flight management system; determining that the flight data is valid based on the version of the flight management system; in response to determining that the flight data is valid, transmitting a confirmation message to the first computing device.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2A shows an example of a whole flight plan contained within a single fragment of a connectivity message.

FIG. 2B shows an example of the flight plan of FIG. 2A fragmented into two separate fragments.

FIG. 3 illustrates an example of an airline client system in accordance with techniques of this disclosure.

FIG. 4 shows an example of a computing device for executing EFB applications in accordance with techniques of this disclosure.

FIG. 5 shows an example of an avionics system in accordance with techniques of this disclosure.

FIG. 6 is a flowchart illustrating an example process for performing offboard flight plan data validation in accordance with techniques of this disclosure.

FIG. 7 is a flowchart illustrating an example process for performing offboard flight plan data validation in accordance with techniques of this disclosure.

Throughout the figures, like reference numerals across multiple figures refer to the same hardware, software, data, step, etc.

### DETAILED DESCRIPTION

The avionics of modern aircraft often include a flight management system (FMS) that can generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, the FMS may ensure that the aircraft is adhering to the flight plan. In this regard, an FMS may be viewed as the custodian of the flight plan.

An electronic flight bag (EFB) may refer to a computing device used by pilots to review operating manuals, airport diagrams, navigational charts, and other types of reference materials that were previously paper-based. More advanced applications for interacting with an FMS and other aspects of an aircraft's avionics are being added to EFBs. With the advent of data connectivity between FMSs and EFBs, flight plans may be sent back and forth between FMSs and EFBs. For example, an FMS may generate a flight plan and supply the flight plan to an EFB for a variety of purposes such as data analytics, visualization, flight plan optimization, or the like. In other examples, an EFB may generate the flight plan and transmit the flight plan to an FMS for the FMS to execute the uploaded flight plan. This EFB-FMS connectivity brings value to the airlines and pilots in terms of situational awareness, flight efficiency, fuel efficiency, predictive maintenance, among other benefits, which can increase revenue and improve safety.

In some situations, an EFB may be configured to fragment a large flight plan, such as a flight plan with a large number of waypoints, into multiple fragments. For example, an EFB may fragment a flight plan that is a few megabytes into fragments that are less than 10 kilobytes. The EFB may then sequentially transmit the fragments to the FMS. When the FMS receives the fragments, the FMS may validate the flight plan by, for example, comparing waypoints and other destinations in the flight plan to a navigational database to confirm that the waypoints correspond to approved waypoints in authorized airspace.

The avionics of an airplane may include specialized computing devices that may not be configured to receive frequent hardware updates. Thus, the processing capabilities of the avionics may be relatively slow compared to the EFB or other newer computing devices. Due to hardware limitations, many avionics systems do not have the ability to buffer, or otherwise store, multiple fragments for long periods of time. Thus, if any one fragment of the flight plan fails the validation, then some FMSs may reject the entire flight plan, requiring the pilot or other user to re-upload the entire flight plan, rather than just the fragment that failed validation, and thus requiring the FMS to re-validate already-validated fragments.

Additionally, EFB-FMS connectivity also potentially presents a security vulnerability that could be exploited by a nefarious actor. For example, cyber criminals could potentially utilize the connectivity channels between EFB applications and avionics to attack, or even take control of, the avionics. For instance, a cybercriminal could take control of an existing EFB application and then, posing as a legitimate EFB application, send malicious commands to the avionics using communication paths allocated for the legitimate EFB applications. Accordingly, EFB-FMS connectivity sessions are typically configured to be highly secure, which often involves limiting the FMS to only communicate with one external device at a time.

Given the relatively slow processing capabilities of the avionics and the fact that other devices may be blocked from communicating with the avionics while the EFB is uploading the flight plan, the process of uploading a flight plan to an FMS can create a bottleneck in the flight preparation process, particularly when a large flight plan fails multiple validation attempts. This disclosure describes techniques that may reduce this bottleneck by having an offboard computing devices, such as a cloud-based device or airport-based device, perform a pre-validation of the flight plan prior to the EFB uploading the flight plan to the FMS. By transmitting the plurality of fragments to an offboard computing device, and then in response to receiving a validation confirmation message from the offboard computing device, transmitting a connectivity message with the flight plan to the FMS, the techniques of this disclosure may reduce the number of times that an FMS will reject the flight plan, which may speed up and generally improve the flight preparation process for pilots. Moreover, the techniques of this disclosure may potentially achieve this benefit without requiring any hardware or software updates to the avionics of an aircraft.

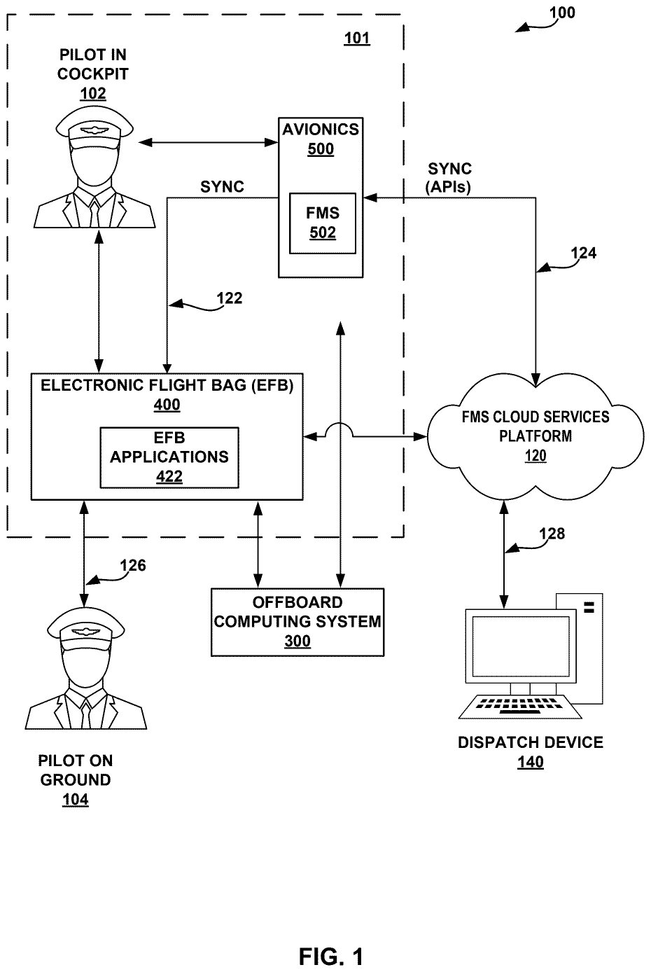

FIG. 1 shows an overview of an example computing environment 100, according to one or more examples of this disclosure. In environment 100, EFB 400 is configured to communicate with avionics 500. EFB 400 and avionics 500 are both devices or systems that may be located inside aircraft 101. Environment 100 also includes a connected FMS cloud services platform 120 (platform 120) and a dispatcher device 140, which may be located outsider of aircraft 101, as well as offboard computing system 300.

EFB 400 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 400 may include a pilot information display (PID).

Avionics 500 generally represents any electronic systems that may be implemented in an aircraft. Avionics 500 may, for example, perform functions related to communication, navigation, safety monitoring, and other such functionality. Avionics 500 includes FMS 502, which represents a specialized computer system configured to automate in-flight tasks according to a flight plan. Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in the cockpit of aircraft 101, may have access to EFB 400 and EFB applications 422 installed on EFB 400. Pilot 102 may also have access to avionics 500 and FMS 502, through which pilot 102 may access the connected FMS cloud services platform 120. EFB applications 422 may access connected FMS cloud services platform 120 and provide the FMS services to the users of EFB 400 in which the EFB applications 422 are installed. In that way, EFB 400 may provide to pilot 102 user-friendly and customized user interfaces, by which pilot 102 may interact with FMS services from the platform 120.

FMS 502 may also be configured to synchronize data 124 with connected FMS cloud services platform 120, using, for example, an application programming interface (API). In addition, FMS 502 may also be configured to synchronize data 122 with EFB applications 422. Thus, in some implementations, FMS 502 may be synchronized with data from both EFB 400 and platform 120 in real-time or at predetermined intervals, in such a way that the pilot 102 may rely on the on-board FMS 502 for all tasks arising in the environment 100.

A pilot 104, e.g., a pilot on the ground, may also access EFB 400 and the EFB applications 422. In some implementations, the pilot 104 and the pilot 102 may be the same pilot, yet under different circumstances (e.g., time and location of the access). Additionally, or alternatively, the pilot 104 may be a different pilot, or another authorized member of the flight crew, who accesses EFB 400 on the ground for an official duty related to the connected FMS cloud services platform 120. While pilot 104 is accessing the EFB applications 422 via EFB 400, the EFB applications 422 may access the connected FMS cloud services platform 120 to receive various FMS services. In that way, EFB 400 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 502, EFB 400, and dispatcher device 140 may include one or more devices capable of receiving, generating, storing, processing, and/or providing information associated with FMS services. For example, FMS 502, EFB 400, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 500, EFB 400, or FMS cloud services platform 120, the systems and devices of this disclosure may be configured to transmit and receive flight plans in the form of a .RTE (route) file, a .FPL file, or other file formats. A .RTE file is a standard file format that may be used by FMS 502 and EFB applications 422 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may may use .RTE files to plan and file flight routes and ensure compliance with air traffic control and safety regulations. A .RTE file may be uploaded from EFB 400 to FMS 502 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 502 and EFB applications 422 may exchange .FPL (flight plan) files, which include similar information as .RTE files and are used for similar purposes as .RTE files, but have a different formatting.

In accordance with the techniques of this disclosure, EFB 400 may receive a flight plan. EFB 400 may, for example, receive the flight plan by pilot 102 or pilot 104 directly inputting the flight plan, or EFB 400 may receive the flight plan via a data link with an external device, such as FMS cloud services platform 120 or offboard computing system 300. EFB 400 may then generate flight plan data for the flight plan. The flight plan data may include, among other types of data, a plurality of waypoints that define the route of aircraft 101. Prior to transmitting the flight plan data to FMS 502, however, EFB 400 may instead transmit a copy of the flight plan data to an external computing device, such as offboard computing system 300 so that offboard computing system 300 may perform a series of validation processes on the flight plan data to ensure that the flight plan data will pass the validation processes performed by FMS 502. In response to receiving a validation confirmation message from offboard computing system 300, EFB 400 may be configured to transmit a connectivity message including the flight plan data to the FMS 502. Due to the flight plan data being pre-validated by offboard computing system 300, the odds are extremely low that the flight plan data will fail the validation processes performed by FMS 502.

As indicated above, FIG. 1 is provided merely as an example. Other examples are possible and may differ from the example illustrated and described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 400 and dispatcher device 140) may be implemented within a single device, or a single device shown in FIG. 1 (e.g., EFB 400, FMS 502, or dispatcher device 140) may be implemented as multiple, distributed devices. Additionally, or alternatively, a set of devices (e.g., one or more devices) of environment 100 may perform one or more functions described as being performed by another set of devices of environment 100.

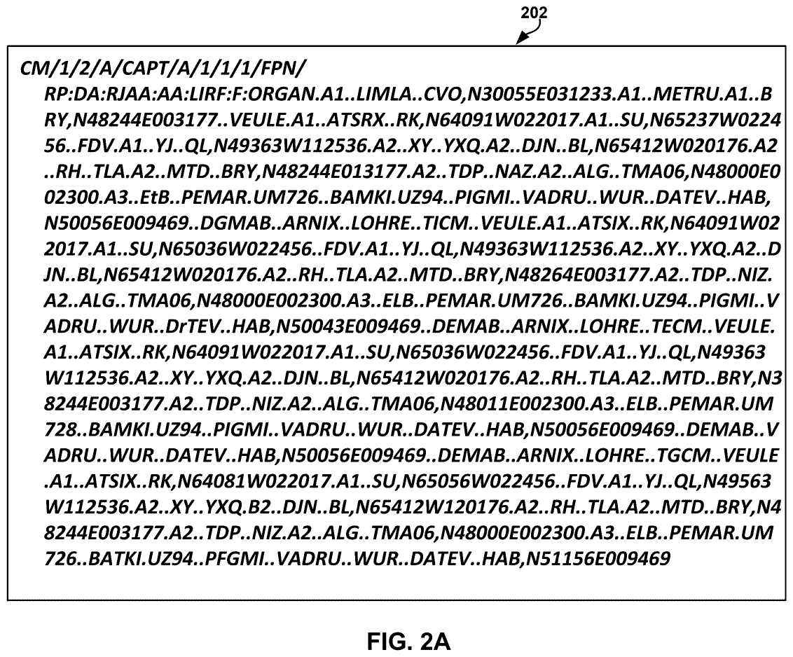

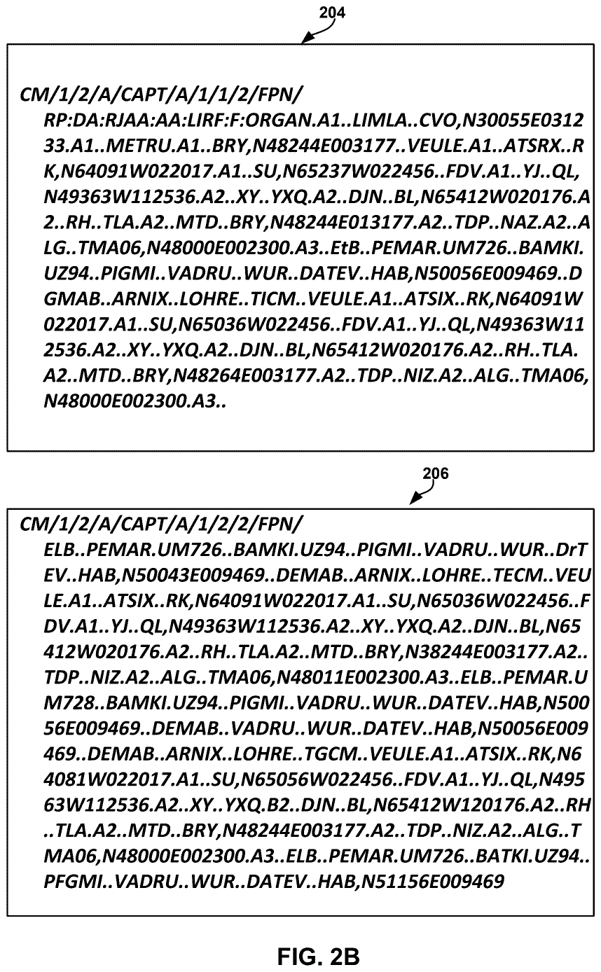

FIG. 2A shows an example of a whole flight plan contained within a single fragment 202 of a connectivity message. In the example of FIG. 2A, the header of single fragment 202, i.e., “CM/1/2/A/CAPT/A/1/1/1/FPN/,” corresponds to the following:
Session Command: CM (Connectivity Message)
Session ID: 1 (SPE 1, 9244)
Command ID: 2
Context ID: A
Device ID: CAPT
Init Type: A
Msg Info ID: 1
Fragment Index: 1
Fragment Count: 1
Payload: Remaining text following the header

FIG. 2B shows an example of the flight plan of FIG. 2A fragmented into two separate fragments, shown as fragment 204 and fragment 206. In the examples of FIGS. 2A and 2B, fragments 204 and 206 have the following headers:

| Fragment 204 | Fragment 206 |
|---|---|
| Session Command: CM | Session Command: CM |
| (Connectivity Message) | (Connectivity Message) |
| Session ID: 1 (SPE 1, 9244) | Session ID: 1 (SPE 1, 9244) |
| Command ID: 2 | Command ID: 2 |
| Context ID: A | Context ID: A |
| Device ID: CAPT | Device ID: CAPT |
| Init Type: A | Init Type: A |
| Msg Info ID: 1 | Msg Info ID: 1 |
| Fragment Index: 1 | Fragment Index: 2 |
| Fragment Count: 2 | Fragment Count: 2 |
| Payload: Remaining text | Payload: Remaining text |
| following the header | following the header |

EFB 400 may be configured to fragment the flight plan data in a manner that is compatible with FMS 502. For example, EFB 400 may be configured to select a fragment size that does not exceed a maximum fragment size. EFB 400 may also be configured to generate a header in a format that FMS 502 can parse. FMS 502 may be configured to perform concatenation, which is generally the inverse of the fragmentation performed by EFB 400. That is, FMS 502 may receive fragments 204 and 206 and concatenate the payload of each, such that the concatenated payload corresponds to the payload of single fragment 202.

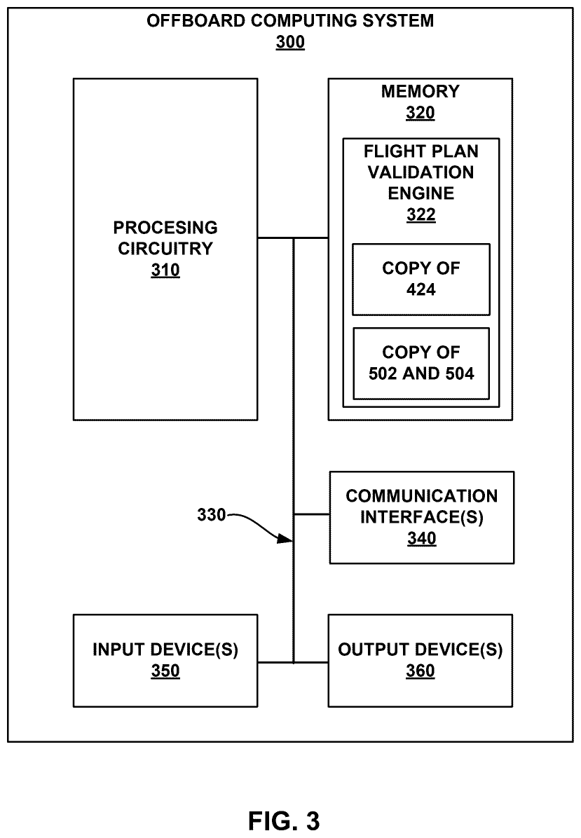

FIG. 3 illustrates an example of offboard computing system 300. Offboard computing system 300 may represent specialized or generic computing hardware configured to store and execute flight plan validation engine 322. In the example of FIG. 3, offboard computing system 300 includes processing circuitry 310, memory 320, communication interface(s) 340, input device(s) 350, and output device(s). The aforementioned components of offboard computing system 300 may be connected to one another through a bus 330, which generally represents one or more busses and is intended to generically represent all the electrical and data connectivity of internal components included within offboard computing system 300.

Processing circuitry 310 may be configured to implement the functionality of and/or execute the instructions associated with flight plan validation engine 322. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, offboard computing system 300 may store instructions for the software in a suitable, non-transitory computer-readable medium (e.g., memory 320) and execute the instructions in hardware using processing circuitry 310 to perform the techniques of this disclosure.

Memory 320 is intended to generically represent some or all memory included within offboard computing system 300. In some implementations, memory 320 may include a plurality of separate devices and memory units. Theses memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). Flight plan validation engine 322 may be stored in any volatile and/or non-volatile memory component of memory 320 and executed by processing circuitry 310.

Communication interface(s) 340 generally represents some or all hardware, e.g., transceiver circuitry, within offboard computing system 300 for communicating with external devices. Communication interface(s) 340 may facilitate communication with external devices via one or more wired and/or wireless network connections by transmitting and/or receiving signals on the one or more networks. Examples of communication interface(s) 340 include a network interface card (e.g., such as an Ethernet card or WiFi card), an optical transceiver, a radio frequency transceiver, or any other type of device that can send and/or receive information. Other examples of communication interface(s) 340 may include short wave radios, cellular data radios, wireless network radios, as well as USB controllers.

In the example of FIG. 3, offboard computing system 300 also includes input device(s) 350 (e.g., a keyboard, mouse, or touchscreen) and output device(s) 360 (e.g., a display, printer). The various examples of input and output devices listed above represent a non-exhaustive list of the types of the types of input and output devices that may be included in input device(s) 350 and output device(s) 360.

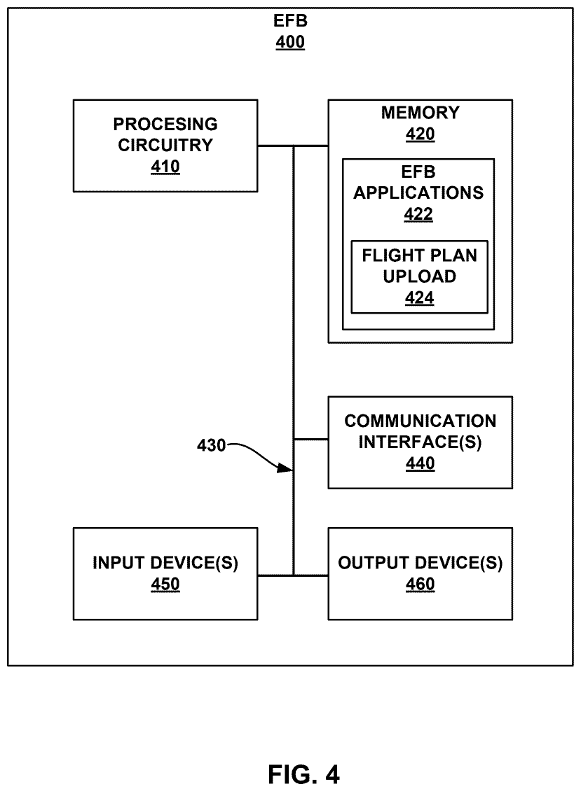

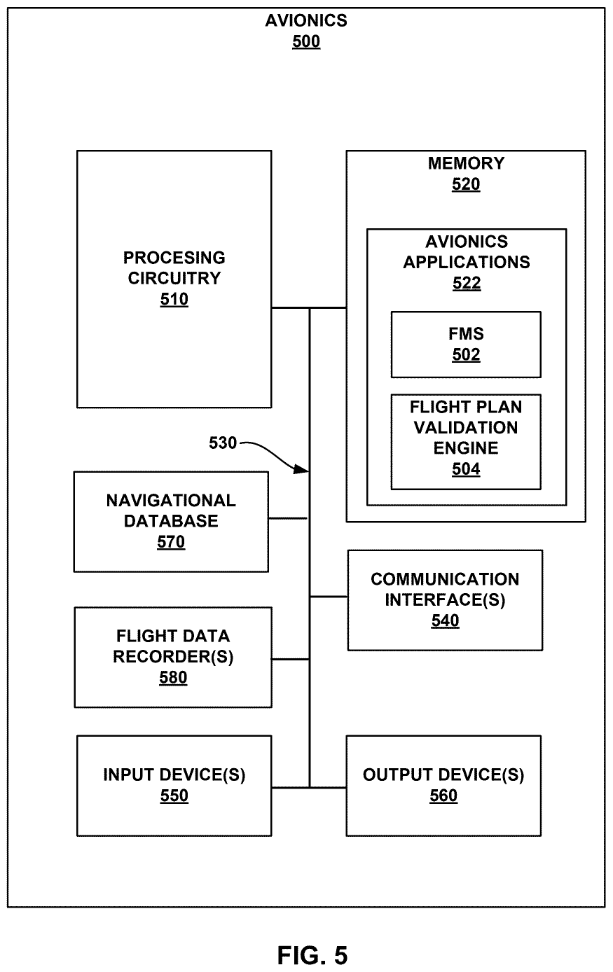

Flight plan validation engine 322 may be configured to perform many of the same processes as flight plan upload application 424 (FIG. 4), FMS 504 (FIGS. 1 and 5), and flight plan validation engine 504 (FIG. 5) in order to confirm that flight plan data generated by upload application 424 will be validated when transmitted to FMS 502 and validated by the flight plan validation engine 504. In this regard, flight plan validation engine 322 may include copies or replications of flight plan upload application 424 (FIG. 4), FMS 502 (FIGS. 1 and 5), and flight plan validation engine 504 (FIG. 5) For example, flight plan validation engine may be configured to generate the same connectivity messages and to reproduce the fragmentation performed by flight plan upload application 424 and to reproduce the same concatenation performed by FMS 502 and flight plan validation engine 504.

In some examples, executing flight plan validation engine 322 causes processing circuitry 310 to receive, from EFB 400 via communication interfaces 240, flight plan data. Processing circuitry 310 determines a version for FMS 502. Processing circuitry may, for example, receive an indication of the version directly from EFB 400 or may receive other information, such as an aircraft identification, from which processing circuitry 310 can determine the version. Processing circuitry 310 then determines if the flight data is valid based on the version. That is, processing circuitry 310 determines the validation processes that FMS 502 will perform when receiving the flight data and performs those same validation processes. Processing circuitry 310 may, for example, determine a navigational database (navigational database 570 in FIG. 5) used by FMS 502 and determine whether or not the flight plan data includes any waypoints identified in the flight plan data are present in the navigational database. If the flight plan data includes any unsupported waypoints, due to data entry error or any other cause, then processing circuitry 310 may transmit to EFB 400 an indication that the second copy of the flight plan data failed to be validated causing EFB 400 to output a notification to a user of EFB 400.n response to determining that the flight data is valid, transmitting a confirmation message to the first computing device.

Processing circuitry 310 may receive multiple requests to validate flight plan data from a plurality EFBs. Processing circuitry 310 may implement prioritization algorithms to determine which request to service first. For example, processing circuitry 310 may be configured to prioritize validation requests associated with active FMS-communication sessions over validation requests for FMS-communication sessions that have not yet been established.

Although offboard computing system 300 is shown in the example of FIG. 3 as being a single device, in many implementations, the functionality attributed to offboard computing system 300 may be performed across multiple devices. From the perspective of EFB 400, offboard computing system 300 may be considered to be a cloud hosting system, and flight plan validation engine 322 may be considered to be a cloud-based application.

FIG. 4 illustrates an example of EFB 400. EFB 400 may be any sort of specific or generic computing hardware, such as a dedicated external flight management device, a tablet computer, phone, laptop computer, desktop computer, or other such computing device, that is configured to store and execute EFB applications. In other examples, EFB 400 may be specialized computing hardware configured to store and execute EFB applications. Some EFBs may be portable and be able to be carried from plane to plane, while other EFBs may be permanently mounted in a specific airplane. In the example of FIG. 4, EFB 400 includes processing circuitry 410, memory 420 which stores EFB applications 422, and communication interface(s) 440 to communicate with other devices. EFB applications 422 may, for example, include a flight plan uploading application 424 for uploading a flight plan from EFB 400 to FMS 502.

Processing circuitry 410 may be configured to implement the functionality of and/or execute the instructions associated with EFB applications 422. Processing circuitry 410 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 400 may store instructions for the software in a suitable, non-transitory computer-readable medium (e.g., memory 420) and execute the instructions in hardware using processing circuitry 410 to perform the techniques of this disclosure.

Memory 420 is intended to generically represent some or all memory included within EFB 400. In some implementations, memory 420 may include a plurality of separate devices and memory units. Theses memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 4 as EFB applications 422) may be stored in any volatile and/or non-volatile memory component of memory 420.

In the example of FIG. 4, EFB 400 also includes input device(s) 450 (e.g., a keyboard, mouse, or touchscreen) and output device(s) 460 (e.g., a display, printer). In implementations where EFB 400 is a phone or tablet computer, then the EFB may, for example, have a touchscreen and a display. In implementations where EFB 400 is a larger computer device, then the EFB may, for example, have a mouse, trackpad, keyboard, or other such input devices. The aforementioned components of EFB 400 may be connected to one another through a bus 430, which generally represents one or more busses and is intended to generically represent all the electrical and data connectivity of internal components included within EFB 400.

Communication interface(s) 440 generally represents some or all hardware, e.g., transceiver circuitry, within EFB 400 for communicating with external devices. Communication interface(s) 440 may facilitate communication with external devices via one or more wired and/or wireless network connections by transmitting and/or receiving signals on the one or more networks. Examples of communication interface(s) 440 include a network interface card (e.g., such as an Ethernet card), an optical transceiver, a radio frequency transceiver, a GPS receiver, or any other type of device that can send and/or receive information. Other examples of communication interface(s) 440 may include short wave radios, cellular data radios, wireless network radios, as well as universal serial bus (USB) controllers. In some examples, communication interface(s) 440 may include an avionics full-duplex switched ethernet (AFDX) interface, also known as ARINC 564.

Communications interface(s) 440 may also be configured to communicate with avionics 500 via an aircraft interface device via wired or wireless communication. Examples of wireless communication include ethernet and USB. Examples of wireless communication include Wi-Fi and Bluetooth.

EFB applications 422 may represent a suite of software tools that may be used by a pilot in managing flight operations. EFB applications 422 may include flight planning applications that allow pilots to create and file flight plans, access weather information, and calculate fuel requirements. EFB applications 422 may also include navigation applications that provide real-time navigation support with maps, airspace information, and waypoint management. EFB applications 422 may also include weather applications that provide real-time weather data, future weather predictions, radar imagery, and the like. EFB applications 422 may also include checklist applications for ensuring compliance with pre-flight, mid-flight, and post-flight procedures. EFB applications 422 may also include various performance analysis tools that, for example, help pilots compute takeoff and landing distances based on current conditions and aircraft configuration. EFB applications 422 may also include aircraft maintenance tracking tools that track aircraft maintenance schedules, inspection records, and compliance records. EFB applications 422 may may also include flight logbooks that enable pilots to log flights, track hours, and generate reports for currency and certification. EFB applications 422 may also include airport information applications that provide information about airports, including runway layouts, services, and notices.

The various example applications listed above represent a non-exhaustive list of the types of applications that may be included in EFB applications 422. As explained above, some applications of EFB applications 422 may facilitate communication with avionics 500 using the data communication techniques of this disclosure.

In some examples, executing flight plan uploading application 424 may cause processing circuitry 410 to receive a flight plan. Processing circuitry 410 may, for example, receive the flight plan data from a pilot or user of EFB 400 via input device(s) 450 or from another device via communication interface(s) 440. Processing circuitry 410 may generate flight plan data for the flight plan. That is, processing circuitry 410 may put the flight plan into a data format for upload to FMS 502. Before transmitting the flight data to FMS 502, however, processing circuitry 410 may transmit, via communications interface(s), a copy of the flight plan data to offboard computing system 300, which is external to the aircraft. Processing circuitry 410 may also transmit an indication of a version for FMS 502. This indication may be a direct identifier of the version of FMS 502 or may be another indicator from which external computing system 300 can derive the version of FMS 502. In response to receiving a validation confirmation message from offboard computing system 300, processing circuitry 410 may transmit, via communications interface(s) 440, a connectivity message including the flight plan data to FMS 502. If the flight plan data fails the validation process, then instead of receiving a validation confirmation message, processing circuitry 410 may receive a notification from offboard computing system 300 that the flight data failed the verification process.

In some examples, executing flight plan uploading application 424 may cause processing circuitry 410 to fragment the flight plan data and transmit the fragments to external computing system 300. In other examples, processing circuitry 410 may send the unfragmented flight plan to offboard computing system 300, and offboard computing system replicates the fragmenting that processing circuitry 410 performs on the flight plan data. In other examples, processing circuitry 410 may fragment the data and generate a plurality of connectivity messages including the fragments, and then transmit the connectivity messages to external computing system 300. In response to receiving a validation confirmation message from offboard computing system 300, processing circuitry 410 may transmit, via communications interface(s) 440, a plurality of connectivity messages including the fragments. Each fragment of the plurality of fragments may include a header with a fragment index and payload that includes a portion of the flight plan data. Processing circuitry 410 may sequentially transmit the plurality of fragments to FMS 502 based on the fragment indices.

In some implementations, processing circuitry 410 may transmit the connectivity message to FMS 502 automatically, e.g., without additional user input, in response to receiving the validation confirmation message from offboard computing system 300. In other implementations, processing circuitry 410 may prompt a user to confirm the transmission prior to transmitting the connectivity message to FMS 502.

EFB 400 may, for example, transmit the flight plan to avionics 500 using a standardized aviation data format and communication protocol. For example, EFB 400 may transmit the flight plan to avionics 500 using the aircraft communications addressing and reporting system (ACARS) Flight Plan Message Format (ARINC 633), FMS Data Exchange Format (ARINC 702A), ARINC 424 Navigation System Data Base Standard, XML-Based Flight Plan Format, or other such appropriate formats. In some examples, EFB 400 may transmit the flight plan, using ethernet or WiFi, to avionics 500 via an aircraft interface device (AID) using the Aircraft Data Interface-ADIF format (ARINC 834). An AID is a hardware component that may serve as a bridge between EFB 400 and avionics 500. The AID may enable secure data exchange while ensuring that uncertified or non-avionics devices do not interfere with critical flight systems.

FIG. 5 illustrates an example of avionics 500. Avionics 500 represents specialized computing hardware configured to store and execute avionics applications. In the example of FIG. 5, avionics 500 includes processing circuitry 510, memory 520 which stores avionics applications 522, communication interface(s) 540 to communicate with other devices, such as EFB 400, input device(s) 550, output device(s) 560, navigational database 570, and flight data recorder(s) 580. The aforementioned components of avionics 500 may be connected to one another through a bus 530, which generally represents one or more busses and is intended to generically represent all the electrical and data connectivity of internal components included within avionics 500.

Processing circuitry 510 may be configured to implement the functionality of and/or execute the instructions associated with avionics applications 522. Processing circuitry 510 may be implemented as any of a variety of suitable circuitry that includes a processing system, such as one or more integrated circuits, microprocessors, digital signal processors DSPs, ASICs, FPGAs, discrete logic, software, hardware, firmware or any combinations thereof. When the techniques are implemented partially in software, avionics 500 may store instructions for the software in a suitable, non-transitory computer-readable medium (e.g., memory 520) and execute the instructions in hardware using processing circuitry 510 to perform the techniques of this disclosure.

Memory 520 is intended to generically represent some or all memory included within avionics 500. In some implementations, memory 520 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 5 as avionics applications 522) may be stored in any volatile and/or non-volatile memory component of memory 520.

Communication interface(s) 540 generally represents some or all hardware e.g., transceiver circuitry, within avionics 500 for communicating with external devices either on the ground or while in flight. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as USB controllers. Examples of communication interface(s) 540 for in-flight communication include a very high frequency (VHF) radio, a high frequency (HF) radio, or a satellite communication (SATCOM) radio.

Examples of communication interface(s) 540 used for data links include ACARS for providing a digital data link system that allows for the exchange of messages between the aircraft and ground stations for purposes such as flight plan updates, weather information, and maintenance reports. Another examples of communication interface(s) 540 used for data links include controller-pilot data link communications (CPDLC) which allows air traffic control to send instructions and receive acknowledgments from pilots via text messages. Communications interface(s) 540 may also include an automatic dependent surveillance-broadcast transponder. The various examples of communications interfaces listed above represent a non-exhaustive list of the types of the types of communication interfaces that may be included in communication interface(s) 540.

Avionics 500 may also include input device(s) 550 and output device(s) 560. Examples of input device(s) 550 include control display units (CDUs) with alphanumeric keypads or touchscreens to enter flight plans, waypoints, and other necessary data. Input device(s) 550 may also include an FMS control panel for entering information to the FMS, such as route, altitude, and speed using dedicated buttons, knobs, and touchscreen interfaces. Input device(s) 550 may also include yoke or sidestick controls as well as touchscreen interfaces. Input device(s) 550 may also include rotary knobs for setting values for altitudes, speeds, and other parameters and toggle switches for selecting modes or turning systems on and off.

Examples of output device(s) 560 may include an electronic flight instrument display to provide visual representations of flight data, including altitude, airspeed, heading, and attitude. Output device(s) 560 may also include a Heads-Up Display (HUD) that projects critical flight information onto a transparent screen in the pilot's line of sight or other cockpit displays to show navigation maps, engine parameters, system statuses, and the like. Output device(s) 560 may also include engine instrumentation displays to display data on engine performance, such as temperature, pressure, and revolutions per minute (RPMs). Output device(s) 560 may also include audio panels to relay communication from radios and alerts from systems to the cockpit. Output device(s) 560 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 550 and output device(s) 560. Additionally, input and output functionality of avionics 500 may facilitated by external devices that are separate from input device(s) 550 and output device(s) 560. For example, EFB 400 may be configured to input data to and output data for avionics 500.

In some examples, avionics applications 522 may represent a suite of software tools that may be used by a pilot in managing flight operations and managing the aircraft while in flight. Avionics applications 522 includes FMS 502 discussed above as well as other applications for communication, navigation, and monitoring within an aircraft. Flight plan validation engine 504 is configured to validate flight plan data received from EFB 400 prior to that flight plan date being executed by FMS 502. Flight plan validation engine 504 is configured to reject invalid flight plan data. As explained above, however, because the flight plan data has already been validated by flight plan engine 322 of offboard computing device 300, the odds of flight plan validation engine 504 rejecting the flight plan data are relatively low. Although FMS 502 and flight plan validation engine 504 are shown separately for purposes of illustrations, in many implementations, FMS 502 and flight plan validation engine 504 will essentially be the same application.

Avionics applications 522, for example, also my include applications for processing and displaying weather radar data and presenting essential flight information such as altitude, airspeed, attitude, and heading to a pilot. Avionics applications 522 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 522 may also include the software to manage various emergency systems (e.g., an emergency locator transmitter, flight data recorder, and cockpit voice recorder) and cabin management systems (e.g., passenger infotainment systems and environmental control systems).

Navigational database 570 may represent a specialized database that stores information needed by FMS 502 for the navigation and operation of an aircraft for purposes such as flight planning, route management, and ensuring safe navigation throughout a flight. Navigational database 570 may, for example, store navigational data according to the ARINC 424 standard, which specifies how navigation data, such as waypoints, airways, terminal procedures, and navigational aids, and other such data, is stored and transmitted.

Navigational database 570 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 570 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 570 may be regularly updated to reflect changes in air traffic regulations, airport information, and navigational aids to ensure pilots have current information for safe and efficient flight operations.

Although not explicitly shown in FIG. 5, avionics 500 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 500 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 580 may be configured to record, and store in memory 520, flight data 582. In some examples, flight data recorder(s) 580 may have dedicated memory, meaning the memory that stores flight data 582 is separate than, for example, the memory that stores avionics applications 522. Flight data recorder(s) 580 may include any combination of one or more flight data recorders including a quick access recorder, a deployable recorder, or a combined cockpit voice recorder and flight data recorder.

Flight data recorder(s) 580 may be configured to record flight dynamics and motion data. For example, flight data recorder(s) 580 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 580 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 580 may also be configured to record crew inputs. For example, flight data recorder(s) 580 may be configured to record control inputs, such as a pilot's inputs on yoke/stick, rudder pedals, and throttle. Flight data recorder(s) 580 may also be configured to record status or positions of switches (e.g., fuel pumps, anti-ice). Flight data recorder(s) 580 may also be configured to record communication controls, such as transponder codes, frequency changes, and communications status.

Flight data recorder(s) 580 may also be configured to record the status of warning and alarm systems, such as the status of alarms such as stall warnings, overspeed warnings, or terrain awareness warnings. Flight data recorder(s) 580 may also be configured to record engine and system alerts, such as malfunction notifications related to engine failures, low hydraulic pressures, or other such warnings. Flight data recorder(s) 580 may also be configured to record crew announcements and chimes.

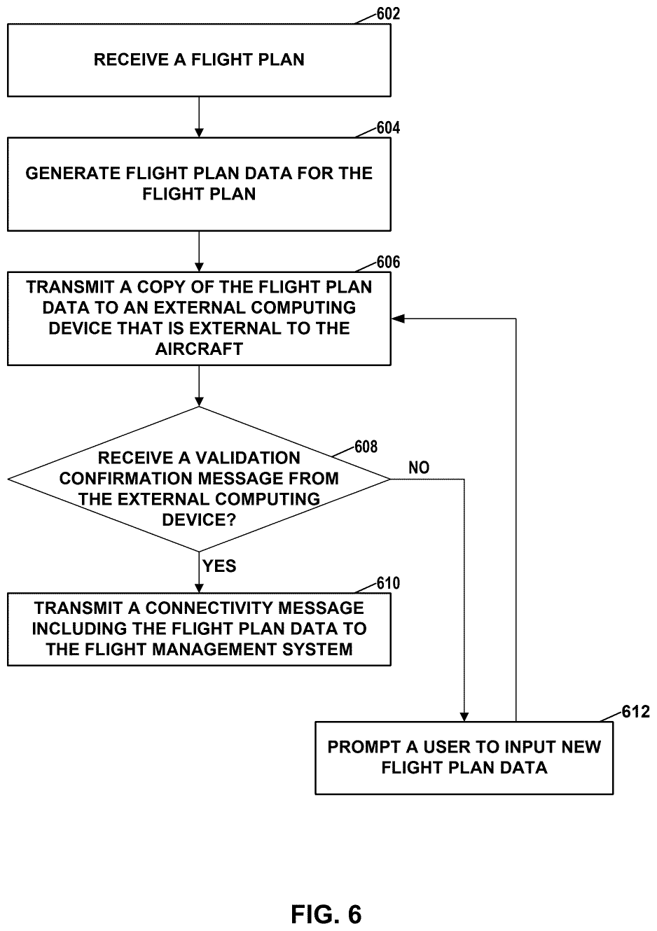

FIG. 6 is a flowchart illustrating an example process for performing offboard flight plan data validation in accordance with techniques of this disclosure. The techniques of FIG. 6 will be described from the perspective of EFB 400 although other types of onboard computing devices may also be configured to perform the techniques of FIG. 6.

In the example of FIG. 6, EFB 400 receives flight plan data (602). EFB 400 may, for example, be in the cockpit of an airplane and receive the flight plan from a pilot entering the flight plan, or EFB 400 may receive the flight plan from an external device in data communication with EFB 400. The flight plan may, for example, include a plurality of waypoints, as well as other information such as a takeoff location, departure location, speeds, cruise altitudes, estimated times at waypoints, weight information, fuel information, etc. EFB 400 generates flight plan data for the flight plan (604). EFB 400 may, for example, generate the flight plan data by putting the flight plan into a format for upload to a flight management system.

Prior to uploading the flight plan data to a flight management system, however, EFB 400 may transmit a copy of the flight plan data to an external computing device that is external to the aircraft (606). EFB 400 may transmit the flight plan data to the external computing device as part of a connectivity message or as part of a plurality of connectivity messages that include fragments of the flight plan data. EFB 400 may additionally transmit to the external computing device, an indication of the version of the flight management system and/or an indication of the version of a navigational database used by the flight management system.

In some examples, EFB 400 may only send some and not all connectivity messages to the external computing device for offboard validation. For example, EFB 400 may be configured to only send connectivity messages that include flight plan data to the external computing device for offboard validation or only send connectivity messages with a payload larger than a threshold size to the external computing device for offboard validation. EFB 400 may also be configured to prioritize messages that are sent to the external computing device for offboard validation over messages that are not sent to the external computing device for offboard validation. By prioritizing messages that are sent to the external computing device for offboard validation over messages that are not sent to the external computing device for offboard validation, EFB 400 may reduce the amount of dead periods during sessions and reduce the risk to timeout errors.

In response to receiving a validation confirmation message from the external computing device (608, yes), EFB 400 may transmit a connectivity message from to the flight management system (610). The messages transmitted by EFB 400 may be time bound, meaning the message is only valid for a certain period of time, such as 60 seconds. Therefore, the external computing device may be configured to wait until after receiving the confirmation message to establish a session with the flight management system to reduce the likelihood of a session time out error occurring.

In response to not receiving a validation confirmation message from the external computing device (608, yes), EFB 400 may prompt a user to input new flight plan data (612). Once the user has input the new flight plan data, then EFB 400 may transmit the new flight plan data to external computing device to perform a new validation on the new flight plan data.

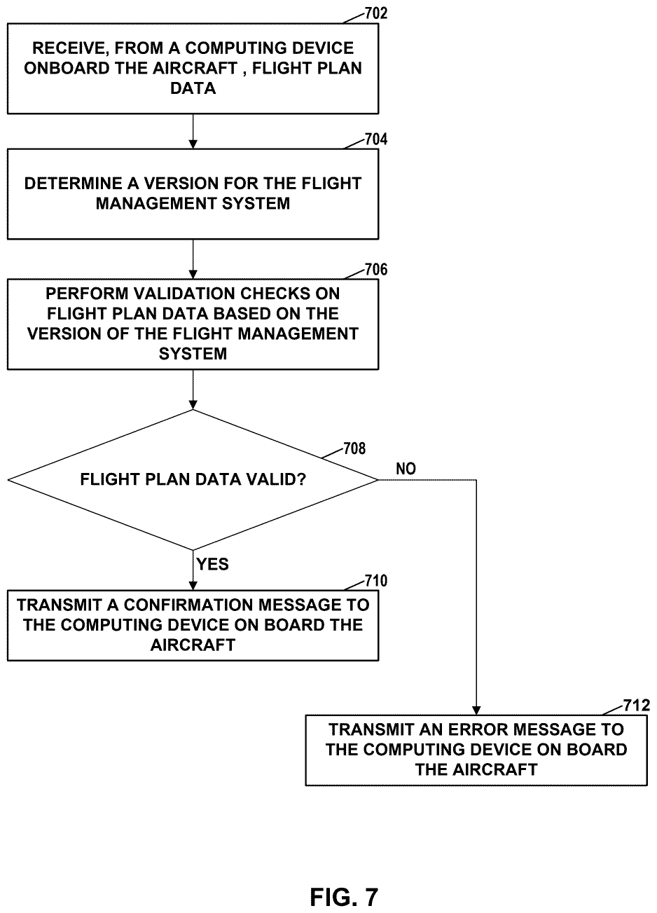

FIG. 7 is a flowchart illustrating an example process for performing offboard flight plan data validation for in accordance with techniques of this disclosure. The techniques of FIG. 7 will be described from the perspective of external computing system 300 although other types of computing systems may also be configured to perform the techniques of FIG. 7.

In the example of FIG. 7, external computing system 300 receives, from a computing device onboard the aircraft, flight plan data (702). External computing system 300 determines a version for the flight management system (704). External computing device 300 performs validation checks on the flight plan data based on the version for the flight management system (706). That is, external computing system 300 selects the validation checks to be performed selected based on the version of the flight management system so that external computing system 300 performs the same validation checks that the flight management system on the aircraft will perform when the flight plan data is uploaded to the flight management system. As part of validating the flight plan data, external computing system 300 may, for example replicate a fragmentation algorithm to be performed by the computing device onboard the aircraft and replicate a concatenation algorithm of the flight management system in order to confirm that concatenated flight plan data ultimately received by the flight management system will be validated by the flight management system.

As part of performing validation checks on the flight plan data, external computing system 300 may be configured to perform data validation to verify the accuracy of the flight plan data. For example, external computing system 300 may check to confirm that altitudes are within acceptable limits for the type of aircraft being flown, that fuel loads are within acceptable limits for aircraft capacity and route length, that the route does not include restricted airspace, and other such validation requests. As part of performing the data validation checks, external computing system 300 may, for example, determine a navigational database for the flight management system and confirm that waypoints identified in the flight plan data are present in the navigational database.

As part of performing validation checks on the flight plan data, external computing system 300 may be configured to confirm that the flight plan data is formatted in accordance with a protocol supported by the flight management system, such as ARINC 424. External computing system 300 may be configured to confirm that the flight plan data is encrypted in accordance with an encryption scheme supported by the flight management system.

As part of performing validation checks on the flight plan data, external computing system 300 may be configured to perform session validation. Referring back to FIGS. 2A and 2B, each fragment includes a session ID. External computing device 300 may be configured validate that a session is active. For example, if external computing device 300 receives a message from the same device for a new session before external computing device 300 is finished validating a message for a prior session, then external computing device 300 may determine that the session for that message has been closed and reject the message.

As part of performing validation checks on the flight plan data, external computing system 300 may, for example, be configured to store historical flight plan data that is known to be valid. For example, a flight from a first destination to a second destination may use the same set of waypoints, with only aspects of the flight plan such as times being changed. Thus, in some instances for commonly used flight plans, external computing system 300 may be able to expedite the validation process without checking the entire flight plan. For example, if portions of a flight plan to be validated are exact copies of portions of previously-validated flight plans, then certain processes such as confirming waypoints are included in a navigational database may be skipped. Similarly, as part of performing validation checks on the flight plan data, external computing system 300 may be configured to store historical flight plan data that is known to be invalid. Thus, in some instances for commonly used flight plans with common errors, external computing system 300 may be able to expedite the validation process without checking the entire flight plan. For example, if a flight plan to be validated is an exact copy of a previously-invalidated flight plan, then certain processes such as confirming waypoints are included in a navigational database or fragmenting and concatenating the flight plan data may be skipped. Skipping these processes may reduce the computational load required for external computing system 300 to validate or invalidate a flight plan, thus enabling external computing system 300 to more quickly process more flight plans.

External computing device 300 may be a cloud-based service provider for many onboard computing devices. External computing device 300 may, for example, receive a plurality of flight plan data verification requests queuing the plurality of flight plan data verification requests based on a prioritization algorithm. External computing device 300 may, for example, prioritize the requests based on aircraft state data, such as give priority to request from aircraft that are in flight versus aircraft on the ground. External computing device 300 may, for example, also prioritize requests if the flight plan data verification request is associated with an active communication session between an EFB and a flight management system.

In response to external computing system 300 determines that the flight data is valid (708, YES), then external computing system 300 transmits a confirmation message to the computing device on board the aircraft (710). In response to external computing system 300 determines that the flight data is invalid (708, NO), then external computing system 300 transmits a different message, e.g., an error message, to the computing device on board the aircraft (712). In this context, an error message may be any sort of message that causes the onboard computing device to alert a user that the flight plan data failed the validation process. The error message may also include a reason or reasons for why the flight plan data failed the validation process. For example, the error message may identify a waypoint that was not found in the navigational database, identify a fuel load that is outside of acceptable limits, or identify an altitude that is outside of acceptable limits.

The following numbered clauses illustrate one or more aspects of the devices and techniques described in this disclosure.

Clause 1. A computer-implemented method of uploading flight management system (FMS) flight plan data from a first computing device to a flight management system of an aircraft, the method comprising: receiving, by the first computing device, a flight plan; converting, by the first computing device, the flight plan into a data format supported by the flight management system to generate the FMS flight plan data; transmitting a copy of the FMS flight plan data to a second computing device that is external to the aircraft; transmitting, from the first computing device to the second computing device, an indication of a version of the flight management system; and in response to receiving, from the second computing device, a validation confirmation message indicating that the FMS flight plan data is valid for the version of the flight management system, transmitting a connectivity message including the FMS flight plan data to the flight management system.

Clause 2. The method of any of clauses 1-3, further comprising: transmitting, from the first computing device to the second computing device, an indication of a version of a navigational database, and wherein the validation confirmation message comprises an indication that the copy of the FMS flight plan data was validated against the version of the navigational database.

Clause 3. The method of clause 1 or 2, wherein transmitting the copy of the FMS flight plan data to the second computing device comprises transmitting the copy of the FMS flight plan data to the second computing device in response to determining that a size of the FMS flight plan data exceeds a threshold size.

Clause 4. The method of any of clauses 1-3, wherein the FMS flight plan data includes a plurality of fragments, and each of the plurality of fragments includes a header comprising a fragment index and payload comprising a portion of the FMS flight plan data.

Clause 5. The method of any of clauses 1-4, wherein transmitting the connectivity message to the flight management system comprises transmitting the connectivity message to the flight management system via an aircraft interface device.

Clause 6. The method of any of clauses 1-5, wherein the first computing device comprises a tablet computing device.

Clause 7. The method of any of clauses 1-6, wherein the FMS flight plan data comprises a plurality of waypoints.

Clause 8. The method of any of clauses 1-7, wherein transmitting the connectivity message to the flight management system comprises automatically transmitting the connectivity message to the flight management system in response to receiving the validation confirmation message from the second computing device.

Clause 9. A computing device onboard an aircraft for uploading flight management system (FMS) flight plan data to a flight management system of an aircraft, the device comprising:
one or more memories; and processing circuitry coupled to the one or more memories and configured to: receive, by the first computing device, a flight plan; convert, by the first computing device, the flight plan into a data format supported by the flight management system to generate the FMS flight plan data; transmit a copy of the FMS flight plan data to a second computing device that is external to the aircraft; transmit, from the first computing device to the second computing device, an indication of a version of the flight management system; and in response to receiving, from the second computing device, a validation confirmation message indicating that the FMS flight plan data is valid for the version of the flight management system, transmit a connectivity message including the FMS flight plan data to the flight management system.

Clause 10. The device of any of clauses 9-11, wherein the processing circuitry is further configured to: transmit, from the first computing device to the second computing device, an indication of a version of a navigational database, and wherein the validation confirmation message comprises an indication that the copy of the FMS flight plan data was validated against the version of the navigational database.

Clause 11. The device of clause 9 or 10, wherein to transmit the copy of the FMS flight plan data to the second computing device, the processing circuitry is configured to transmit the copy of the FMS flight plan data to the second computing device in response to determining that a size of the FMS flight plan data exceeds a threshold size.

Clause 12. The device of any of clauses 9-11, wherein the FMS flight plan data includes a plurality of fragments, and each of the plurality of fragments includes a header comprising a fragment index and payload comprising a portion of the FMS flight plan data.

Clause 13. The device of any of clauses 9-12, wherein to transmit the connectivity message to the flight management system, the processing circuitry is configured to transmit the connectivity message to the flight management system via an aircraft interface device.

Clause 14. The device of any of clauses 9-13, wherein the device comprises a tablet computing device.

Clause 15. The device of any of clauses 9-14, wherein the FMS flight plan data comprises a plurality of waypoints.

Clause 16. The device of any of clauses 9-15, wherein to transmit the connectivity message to the flight management system, the processing circuitry is configured to automatically transmit the connectivity message to the flight management system in response to receiving the validation confirmation message from the second computing device.

Clause 17. The device of any of clauses 9-16, wherein the processing circuitry is further configured: in response to receiving, from the second computing device, an indication that the copy of the FMS flight plan data failed to be validated, output a notification to a user of the device.

Clause 18. A computer-implemented method of validating flight management system (FMS) flight plan data for a flight management system of an aircraft, the method comprising: receiving, from a first computing device onboard the aircraft by a second computing device offboard the aircraft, the FMS flight plan data; determining a version for the flight management system; determining that the FMS flight data is valid based on the version of the flight management system; in response to determining that the FMS flight data is valid, transmitting a confirmation message to the first computing device.

Clause 19. The method of clause 18, wherein determining that the flight data is valid based on the version of the flight management system comprises: determining a navigational database for the flight management system; and determining that waypoints identified in the FMS flight plan data are present in the navigational database.

Clause 20. The method of clause 18 or 19, wherein determining that the flight data is valid based on the version of the flight management system comprises: replicating, on the FMS flight plan data, a fragmentation algorithm of an application on the first computing device to generate fragmented FMS flight plan data; replicating, on the fragmented FMS flight plan data, a concatenation algorithm of the flight management system to generate concatenated FMS flight plan data; and determining that the concatenated FMS flight plan data is valid.

Clause 21. The method of any of clauses 18-20, wherein determining that the FMS flight data is valid based on the version of the flight management system comprises: determining that the FMS flight plan data is formatted in accordance with a protocol supported by the flight management system.

Clause 22. The method of clause 21, wherein the protocol is ARINC 424.

Clause 23. The method of any of clauses 18-22, wherein determining that the FMS flight data is valid based on the version of the flight management system comprises: determining that the FMS flight plan data is encrypted in accordance with an encryption scheme supported by the flight management system.

Clause 24. The method of any of clauses 18-22, further comprising: receiving, by the second computing device from a plurality of computing devices onboard a plurality of aircraft, a plurality of FMS flight plan data verification requests; and queuing the plurality of FMS flight plan data verification requests based on a prioritization algorithm.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method of uploading flight management system (FMS) flight plan data from a first computing device to a flight management system of an aircraft, the method comprising:
receiving, by the first computing device, a flight plan;
converting, by the first computing device, the flight plan into a data format supported by the flight management system to generate the FMS flight plan data;
transmitting a copy of the FMS flight plan data to a second computing device that is external to the aircraft;
transmitting, from the first computing device to the second computing device, an indication of a version of the flight management system; and
in response to receiving, from the second computing device, a validation confirmation message indicating that the FMS flight plan data is valid for the version of the flight management system, transmitting a connectivity message including the FMS flight plan data to the flight management system.

2. The method of claim 1, further comprising:
transmitting, from the first computing device to the second computing device, an indication of a version of a navigational database, and wherein the validation confirmation message comprises an indication that the copy of the FMS flight plan data was validated against the version of the navigational database.

3. The method of claim 1, wherein transmitting the copy of the FMS flight plan data to the second computing device comprises transmitting the copy of the FMS flight plan data to the second computing device in response to determining that a size of the FMS flight plan data exceeds a threshold size.

4. The method of claim 1, wherein the FMS flight plan data includes a plurality of fragments, and each of the plurality of fragments includes a header comprising a fragment index and payload comprising a portion of the FMS flight plan data.

5. The method of claim 1, wherein transmitting the connectivity message to the flight management system comprises transmitting the connectivity message to the flight management system via an aircraft interface device.

6. The method of claim 1, wherein the first computing device comprises a tablet computing device.

7. The method of claim 1, wherein the FMS flight plan data comprises a plurality of waypoints.

8. The method of claim 1, wherein transmitting the connectivity message to the flight management system comprises automatically transmitting the connectivity message to the flight management system in response to receiving the validation confirmation message from the second computing device.

9. A first computing device onboard an aircraft for uploading flight management system (FMS) flight plan data to a flight management system of an aircraft, the first computing device comprising:
one or more memories; and
processing circuitry coupled to the one or more memories and configured to:
receive, by the first computing device, a flight plan;
convert, by the first computing device, the flight plan into a data format supported by the flight management system to generate the FMS flight plan data;
transmit a copy of the FMS flight plan data to a second computing device that is external to the aircraft;
transmit, from the first computing device to the second computing device, an indication of a version of the flight management system; and
in response to receiving, from the second computing device, a validation confirmation message indicating that the FMS flight plan data is valid for the version of the flight management system, transmit a connectivity message including the FMS flight plan data to the flight management system.

10. The first computing device of claim 9, wherein the processing circuitry is further configured to:
transmit, from the first computing device to the second computing device, an indication of a version of a navigational database, and wherein the validation confirmation message comprises an indication that the copy of the FMS flight plan data was validated against the version of the navigational database.

11. The first computing device of claim 9, wherein to transmit the copy of the FMS flight plan data to the second computing device, the processing circuitry is configured to transmit the copy of the FMS flight plan data to the second computing device in response to determining that a size of the FMS flight plan data exceeds a threshold size.

12. The first computing device of claim 9, wherein the FMS flight plan data includes a plurality of fragments, and each of the plurality of fragments includes a header comprising a fragment index and payload comprising a portion of the FMS flight plan data.

13. The first computing device of claim 9, wherein to transmit the connectivity message to the flight management system, the processing circuitry is configured to transmit the connectivity message to the flight management system via an aircraft interface device.

14. The first computing device of claim 9, wherein the device comprises a tablet computing device.

15. The first computing device of claim 9, wherein the FMS flight plan data comprises a plurality of waypoints.

16. The first computing device of claim 9, wherein to transmit the connectivity message to the flight management system, the processing circuitry is configured to automatically transmit the connectivity message to the flight management system in response to receiving the validation confirmation message from the second computing device.

17. The first computing device of claim 9, wherein the processing circuitry is further configured to:
in response to receiving, from the second computing device, an indication that the copy of the FMS flight plan data failed to be validated, output a notification to a user of the device.

18. A computer-implemented method of validating flight management system (FMS) flight plan data for a flight management system of an aircraft, the method comprising:
receiving, from a first computing device onboard the aircraft by a second computing device offboard the aircraft, the FMS flight plan data;
determining a version for the flight management system;
determining that the FMS flight data is valid based on the version of the flight management system;
in response to determining that the FMS flight data is valid, transmitting a confirmation message to the first computing device.

19. The method of claim 18, wherein determining that the flight data is valid based on the version of the flight management system comprises:
determining a navigational database for the flight management system; and
determining that waypoints identified in the FMS flight plan data are present in the navigational database.

20. The method of claim 18, wherein determining that the flight data is valid based on the version of the flight management system comprises:
replicating, on the FMS flight plan data, a fragmentation algorithm of an application on the first computing device to generate fragmented FMS flight plan data;
replicating, on the fragmented FMS flight plan data, a concatenation algorithm of the flight management system to generate concatenated FMS flight plan data; and
determining that the concatenated FMS flight plan data is valid.
